(19) United States
(12) Patent Application Publication
(10) Pub. No.: US 2010/0124442 A1
(43) Pub. Date: May 20, 2010

(54) DEVELOPING DEVICE, DEVELOPING METHOD, AND IMAGE FORMING APPARATUS

(75) Inventors: Takashi Hatakeyama, Kanagawa (JP); Minoru Yoshida, Tokyo (JP); Takao Izumi, Kanagawa (JP); Hiroshi Murata, Kanagawa (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/619,728

(22) Filed: Nov. 17, 2009

Related U.S. Application Data
(60) Provisional application No. 61/115,180, filed on Nov. 17, 2008.

(51) Int. Cl. G03G 15/08

(52) U.S. Cl. 399/254

(57) ABSTRACT

A developing device includes: a container configured to store a developer and have an agitating passage for supplying the developer to a developing roller; a rotatable agitating member configured to carry the developer along the agitating passage while agitating the developer; a discharge port configured to be provided a container wall surface on a side on which the developer is scraped down in the agitating passage and discharge an excess developer involved in the supply of the developer; and a heaping member configured to heap the developer near the discharge port and discharge the developer from the discharge port.

### CROSS-REFERENCE TO RELATED APPLICATION

This application is based upon and claims the priority of U.S. Provisional Application No. 61/115,180, filed on Nov. 17, 2008, the entire contents of which are incorporated herein by reference.

### TECHNICAL FIELD

The present invention relates to an image forming apparatus of an electrophotographic recording system that superimposes toners of plural colors one on top of another to obtain a color image, and, more particularly to an improvement of a developing device.

### BACKGROUND

In general, in an image forming apparatus of an electrophotographic recording system, plural photoconductive drums are arranged in parallel and laser beams are irradiated on the respective photoconductive drums to form electrostatic latent images. The photoconductive drums have toner images of respective colors formed by developing devices and multiply transfer the toner images of the respective colors onto sheet paper to obtain a color image.

The developing devices are respectively provided for the photoconductive drums. Plural toner cartridges are arranged to supply toners to the developing devices. The toners stored in the toner cartridges are carried to the developing devices. The developing devices include developing rollers for shifting the toners to the photoconductive drums and mixers that agitate the toners and carriers. The developing rollers and the mixers are rotated by motors.

A developing device using a two-component developer including a toner and a carrier has advantages such as stability of an image quality and durability of the device. However, since the developer is deteriorated, necessary to supply the developer to the developing device. Also necessary to discharge an excess developer according to the supply of the developer.

JP-B-2-21591 discloses a developing device including agitating means for agitating a carrier and a toner. In JP-B-2-21591, during toner supply, a developer as a mixture of a new toner and a new carrier is supplied into the developing device, an excess developer is caused to overflow from a discharge port, and a deteriorated developer is replaced with the new toner and the new carrier. However, the developer that does not need to be discharged is splashed by a mixer and discharged from the discharge port.

JP-A-2000-112238 discloses a developing device in which a member for preventing scattering of a developer is provided to be opposed to a discharge port for discharging an excess developer. However, since the developer is unnecessarily heaped and the developer that does not need to be discharged is discharged, stable discharge cannot be performed.

### SUMMARY

According to an aspect of the present invention, there is provided a developing device including:

a developing roller configured to shift a toner onto the surface of an image bearing member;

a container configured to store a developer and have an agitating passage for supplying the developer to the developing roller, the agitating passage having a first wall surface and a second wall surface opposed to each other;

a rotatable agitating member configured to carry the developer along the agitating passage while agitating the developer;

a discharge port configured to be provided in one of the first wall surface and the second wall surface and discharge an excess developer involved in the supply of the developer; and

a heaping member configured to heap the developer relatively to the discharge port according to the agitation of the agitating member, wherein

the discharge port is located in a direction in which the developer is scraped down according to the agitation of the agitating member.

### DESCRIPTION OF THE DRAWINGS

FIG. 1 is a front view of an image forming apparatus according to an embodiment;

FIG. 2 is an enlarged view of the internal structure of the image forming apparatus;

FIG. 3 is a front view of a developing device according to the embodiment;

FIG. 4A is a plan view of the developing device shown in FIG. 3;

FIG. 4B is a partially enlarged view of the developing device shown in FIG. 3;

FIG. 5 is a side view of the developing device shown in FIG. 3;

FIG. 6 is an evaluation table of density unevenness and a spill of a developer with respect to a developer amount;

FIG. 7 is a diagram for explaining fluctuation height during discharge of the developer;

FIG. 8 is a characteristic chart of a rate of increase of the developer with respect to the fluctuation height of the developer;

FIG. 9 is a front view of a developing device having structure for scraping up the developer;

FIG. 10 is a plan view of the developing device shown in FIG. 9;

FIG. 11 is a side view of the developing device shown in FIG. 9;

FIG. 12 is a characteristic chart of the fluctuation height of the developer in a scraping-down structure and a scraping-up structure;

FIGS. 13A to 13E are diagrams for explaining the movement of the developer in the scraping-down structure;

FIGS. 14A and 14B are diagrams for explaining the movement of the developer in the scraping-up structure;

FIG. 15 is a diagram for explaining an angle of repose of the developer;

FIG. 16 is a characteristic chart of the fluctuation height of the developer according to a difference in the angle of repose;

FIGS. 17A to 17E are diagrams for explaining the movement of a developer having a high angle of repose;

FIG. 18 is a plan view of a developing device in which a developing roller and a mixer rotate in “with” directions;

FIG. 19 is a front view of the developing device shown in FIG. 18;

FIG. 20 is an evaluation table of evaluation of printing by rotation in “against” directions and the “with” directions;

FIG. 21 is a characteristic chart of the fluctuation height of the developer with respect to a change in a pitch of a screw blade of a heaping member; and

FIG. 22 is a characteristic chart of the fluctuation height of the developer with respect to a change in the height of the screw blade of the heaping member.

### DETAILED DESCRIPTION

Throughout this description, the embodiment and example shown should be considered exemplars, rather than limitations on the apparatus of the present invention.

An image forming apparatus according to an embodiment of the present invention is explained in detail below with reference to the accompanying drawings. In the drawings, the same components are denoted by the same reference numerals and signs.

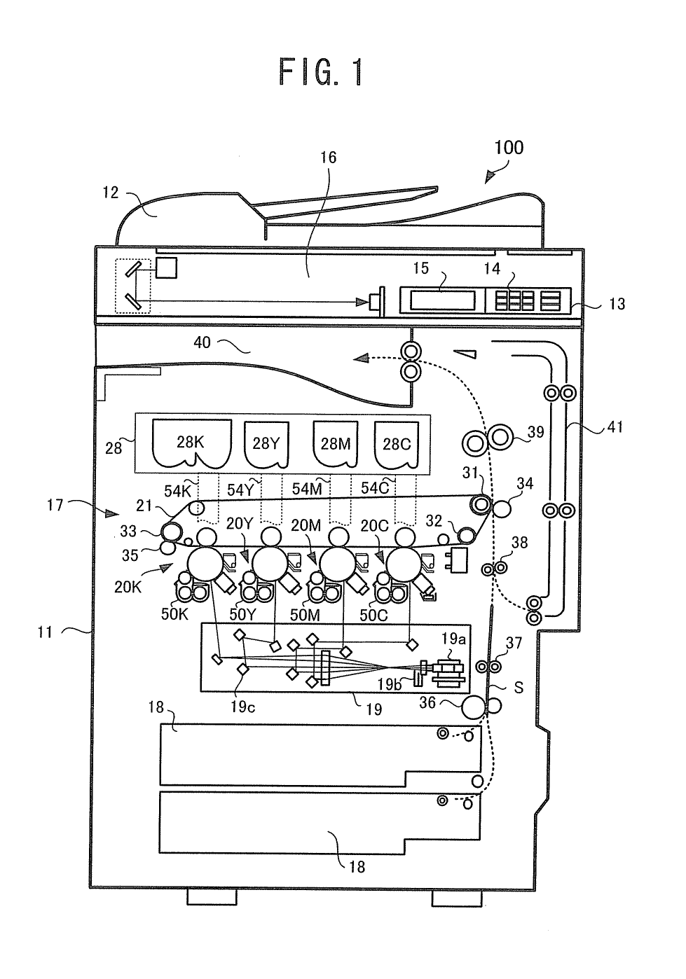

FIG. 1 is a front view of the image forming apparatus according to the embodiment. In FIG. 1, reference numeral 100 denotes the image forming apparatus, which is, for example, a MFP (Multi-Function Peripheral) as a machine having multiple functions, a printer, or a copying machine. In the following explanation, the MFP is explained as an example.

A document table is provided in an upper part of a main body 11 of the MFP 100. An auto document feeder (ADF) 12 is openably and closably provided on the document table. An operation panel 13 is provided in the upper part of the main body 11. The operation panel 13 includes an operation unit 14 including various keys and a display unit 15 of a touch panel type.

A scanner unit 16 is provided below the ADF 12 in the main body 11. The scanner unit 16 reads a document fed by the ADF 12 or a document placed on the document table and generates image data. A printer unit 17 is provided in the center in the main body 11. Plural cassettes 18 that store sheets of various sizes are provided in a lower part of the main body 11.

The printer unit 17 includes photoconductive drums, lasers, and the like. The printer unit 17 processes the image data read by the scanner unit 16 or image data created by a PC (Personal Computer) or the like to form an image on a sheet.

The sheet having the image formed by the printer unit 17 is discharged to a paper discharge unit 40. The printer unit 17 is, for example, a tandem color laser printer. The printer unit 17 scans a photoconductive member with a laser beam from a laser exposing device 19 and generates an image on the photoconductive member.

The printer unit 17 includes image forming units 20K, 20Y, 20M, and 20C for respective colors of black (K), yellow (Y), magenta (M), and cyan (C). The image forming units 20K, 20Y, 20M, and 20C are arranged in parallel on the lower side of an intermediate transfer belt 21 from an upstream side to a downstream side.

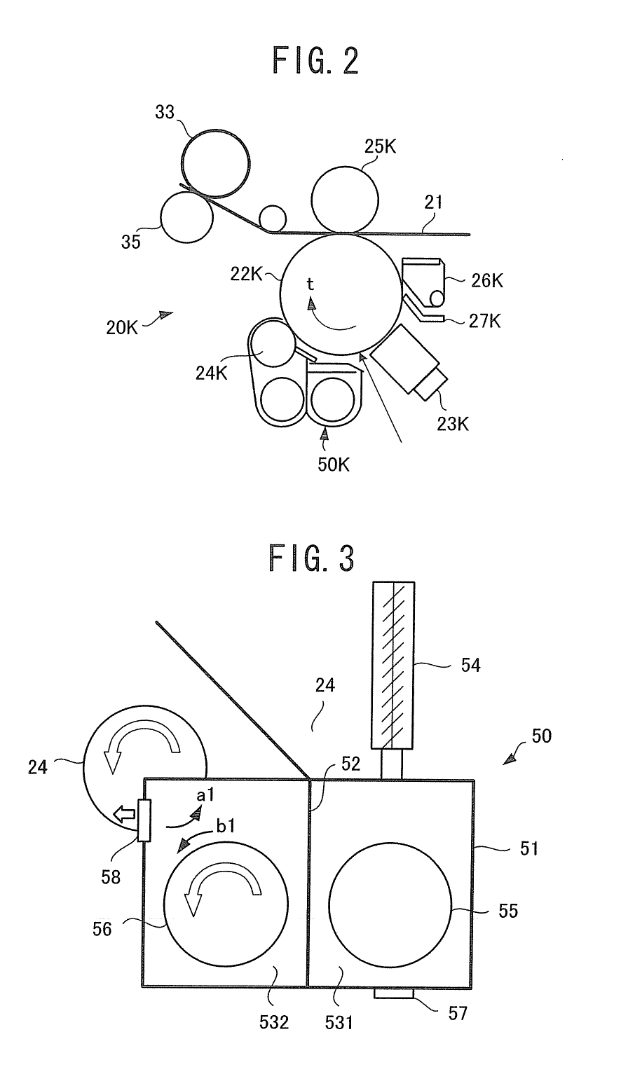

Since the image forming units 20K, 20Y, 20M, and 20C have the same configuration, the image forming unit 20K is explained as a representative image forming unit. The configuration of the image forming unit 20K is shown in enlargement in FIG. 2.

In FIG. 2, the image forming unit 20K includes a photoconductive drum 22K as an image bearing member. An electrifying charger 23K, a developing device 50K including a developing roller 24K, a primary transfer roller 25K, a cleaner 26K, a blade 27K, and the like are arranged around the photoconductive drum 22K along a rotating direction t. The laser exposing device 19 irradiates a black laser beam on an exposing position of the photoconductive drum 22K to form an electrostatic latent image on the photoconductive drum 22K.

The electrifying charger 23K of the image forming unit 20K uniformly charges the entire surface of the photoconductive drum 22K. The developing device 50K includes mixers (explained later) that agitate a developer and the developing roller 24K to which developing bias is applied. The developing device 50K supplies, with the developing roller 24K, a two-component developer including a toner and a carrier to the photoconductive drum 22K. The cleaner 26K removes a residual toner on the surface of the photoconductive drum 22K using the blade 27K.

As shown in FIG. 1, a developer cartridge 28 that supplies developers to the developing devices 50K, 50Y, 50M, and 50C is provided above the image forming units 20K, 20Y, 20M, and 20C. In the developer cartridge 28, developer cartridges 28K, 28Y, 28M, and 28C for the respective colors of black (K), yellow (Y), magenta (M), and cyan (C) are adjacent to one another.

Toner hoppers 54K, 54Y, 54M, and 54C that supply the developers are arranged between the developer cartridges 28K, 28Y, 28M, and 28C and the developing devices 50K, 50Y, 50M, and 50C. In FIG. 1, the specific configuration of the toner hoppers 54K, 54Y, 54M, and 54C is not shown.

The intermediate transfer belt 21 as a recording medium cyclically moves. For example, semi-conductive polyimide is used for the intermediate transfer belt 21 from the viewpoint of heat resistance and abrasion resistance. The intermediate transfer belt 21 is stretched and suspended around a driving roller 31 and driven rollers 32 and 33. The intermediate transfer belt 21 is opposed to and set in contact with the photoconductive drums 22K to 22C.

The primary transfer roller 25K applies primary transfer voltage to a position of the intermediate transfer belt 21 opposed to the photoconductive drum 22K and primarily transfers a toner image on the photoconductive drum 22K onto the intermediate transfer belt 21.

A secondary transfer roller 34 is arranged to be opposed to the driving roller 31 that stretches and suspends the intermediate transfer belt 21. When a sheet S passes between the driving roller 31 and the secondary transfer roller 34, the secondary transfer roller 34 applies secondary transfer voltage to the intermediate transfer belt 21 to secondarily transfer the toner image on the intermediate transfer belt 21 onto the sheet S. A belt cleaner 35 is provided near the driven roller 33 of the intermediate transfer belt 21.

The laser exposing device 19 includes a polygon mirror 19a, a focusing lens system 19b, and a mirror 19c. The laser exposing device 19 scans a laser beam, which is emitted from a semiconductor laser element, in an axis direction of the photoconductive drums 22K to 22C.

A separation roller 36 that extracts the sheet S in the paper feeding cassettes 18, conveying rollers 37, and registration rollers 38 are provided along a path extending from the paper feeding cassettes 18 to the secondary transfer roller 34. A fixing device 39 is provided downstream of the secondary transfer roller 34.

The paper discharge unit 40 and a reversing conveying path 41 are provided downstream of the fixing device 39. A sheet from the fixing device 39 is discharged to the paper discharge unit 40. The reversing conveying path 41 reverses the sheet S and guides the sheet S in the direction of the secondary transfer roller 34. The reversing conveying path 91 is used when duplex printing is performed.

The operation of the image forming apparatus 100 shown in FIGS. 1 and 2 is explained below. When image data is input from the scanner unit 16, the PC, or the like, the image forming units 20K to 20C sequentially form images.

The image forming unit 20K is explained as an example. The laser exposing device 19 irradiates a laser beam corresponding to image data of black (K) on the photoconductive drum 22K to form an electrostatic latent image. The developing device 50K develops the electrostatic latent image on the photoconductive drum 22K to form a black (K) toner image.

The photoconductive drum 22K comes into contact with the rotating intermediate transfer belt 21 and primarily transfers, with the primary transfer roller 25K, the black (K) toner image onto the intermediate transfer belt 21. After the photoconductive drum 22K primarily transfers the toner image onto the intermediate transfer belt 21, a residual toner on the photoconductive drum 22K is removed by the cleaner 26K and the blade 27K. And possible to perform the next image formation.

In the same manner as the toner image forming process for black (K), the image forming units 20Y to 20C form toner images of yellow (Y), magenta (N), and cyan (C), sequentially transfer the toner images to a position same as the position of the yellow (Y) toner image on the intermediate transfer belt 21 and multiply transfer the yellow (Y), magenta (N), and cyan (C) toner images onto the intermediate transfer belt 21 to obtain a full color toner image.

The intermediate transfer belt 21 collectively secondarily transfers the full color toner image onto the sheet S with transfer bias of the secondary transfer roller 34. In synchronization with the full color toner image on the intermediate transfer belt 21 reaching the secondary transfer roller 34, the sheet S is fed from the paper feeding cassette 18 to the secondary transfer roller 34.

The sheet S having the toner image secondarily transferred reaches the fixing device 39. The toner image is fixed on the sheet S. The sheet S having the toner image fixed is discharged to the discharge unit 40. On the other hand, after the secondary transfer ends, the belt cleaner 35 cleans a residual toner on the intermediate transfer belt 21.

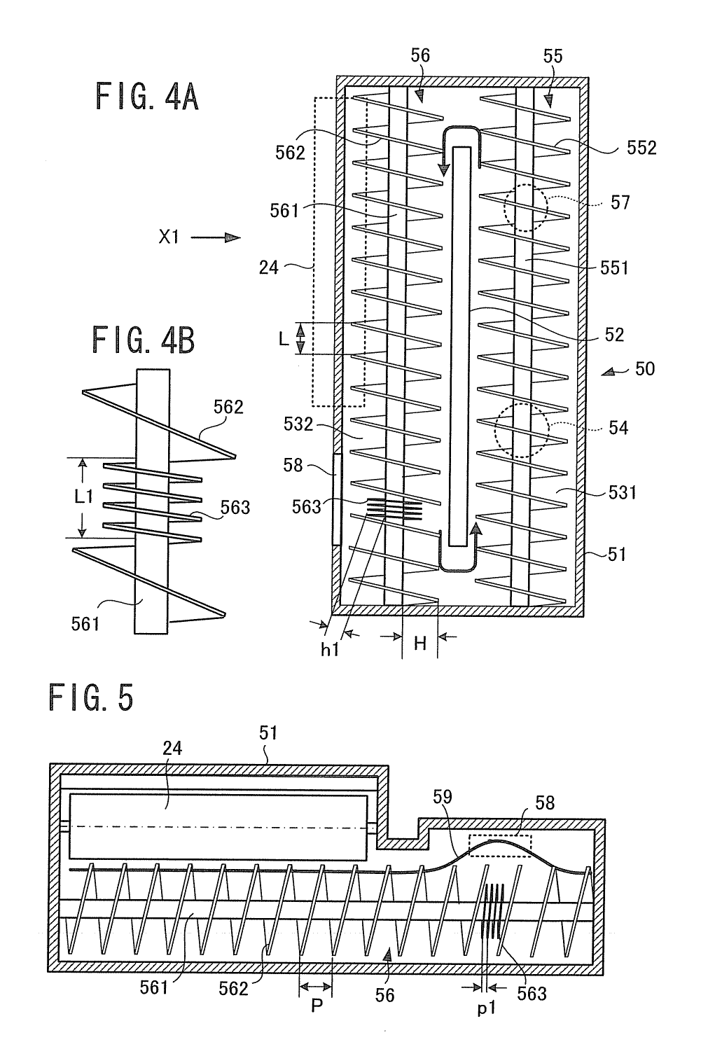

A developing device 50 representing the developing devices 50K, 50Y, 50M, and 50C is explained in detail below with reference to FIGS. 3 to 5. FIG. 3 is a front view of the developing device 50. FIG. 4A is a plan view of FIG. 3 and FIG. 4B is a partial enlarged view of FIG. 3. FIG. 5 is a side view of the developing device 50 viewed from an arrow X1 direction in FIG. 4A. A part of the developing device 50 is shown in section.

The developing devices 50K, 50Y, 50M, and 50C are provided to correspond to the developing rollers 24K, 24Y, 24M, and 24C. However, since the developing devices 50K, 50Y, 50M, and 50C, the developing rollers 24K, 24Y, 24M, and 24C, and other components respectively have the same configurations, the signs K, Y, M, and C are omitted in the following explanation.

In FIG. 3, the developing device 50 includes a developer container 51. The developer container 51 is arranged substantially in parallel to the axis direction of the photoconductive drum 22. The developing roller 24 is rotatably provided in the developer container 51.

The developing roller 24 has a magnet in the inside and is also called magnet roller. The developing roller 24 is opposed to the photoconductive drum 22. A carrier and a toner are carried on the surface of the developing roller 24. The developing roller 24 rotates to feed the toner onto the photoconductive drum 22.

The developer container 51 is partitioned into two spaces 531 and 532 by a partition plate 52. The toner hopper 54 supplies a developer to one space 531.

A first mixer 55 is provided in one space 531 of the developer container 51. A second mixer 56 is provided in the other space 532. The mixers 55 and 56 configure an agitating member that agitates and carries the developer (the toner and the carrier) in the developer container 51 and supplies the developer to the developing roller 24.

As shown in FIG. 4A, the mixers 55 and 56 have first screw blades 552 and 562 having a spiral shape attached to rotating shafts 551 and 561. The mixers 55 and 56 agitate and carry the developer according to the rotation of the first screw blades 552 and 562. As indicated by a thick like shown in FIG. 4, the developer in the developer container 51 is circulated to be carried from the front to the depth of the space 531 and carried in the counterclockwise direction from the depth to the front of the space 532. The spaces 531 and 532 configure an agitating passage. The agitating passage has a first wall surface and a second wall surface opposed to each other.

A toner density sensor 57 (FIG. 3) is provided in the space 531. The toner density sensor 57 detects toner density of the developer agitated and carried by the mixer 55. When the toner density detected by the toner density sensor 57 falls to be equal to or lower than a value set in advance, the developer including the toner and the carrier is supplied from the toner hopper 54.

A discharge port 58 is provided in the developer container 51. In FIG. 5, the developer is agitated and carried from the left to right. A discharge port is provided in a position indicated by a broken line 58. An excess developer is discharged from the discharge port 58 by an overflow. A heaping member (a second screw blade 563) that heaps the developer relatively to the discharge port 58 is provided in a section of the mixer 56 opposed to the discharge port 58. As shown in FIG. 4B in enlargement, the second screw blade 563 is provided coaxially with the first screw blade 562 and has a diameter and a pitch smaller than a diameter and a pitch of the first screw blade 562.

In this embodiment, the developer is heaped and discharged from the discharge port 58. A thick solid line 59 shown in FIG. 5 indicates a developer surface. The developer surface 59 rises in the section of the discharge port 58 because the outer diameter of the second screw blade 563 of the mixer 56 is set small. Since an action for circulating and agitating the developer is reduced only in the section of the second screw blade 563, the developer can be heaped. As shown in FIGS. 3 and 5, the discharge port 58 is arranged above the mixer 56.

As shown in FIG. 3, the mixer 56 rotates in a direction (an arrow b1) in which the mixer 56 scrapes down the developer from up to down near the discharge port 58. Opposed surfaces of the developing roller 24 and the mixer 56 rotate in opposite directions (“against” directions) as indicated by arrows a1 and b1.

As the shape of the second screw blade 563 near the discharge port 58 of the mixer 56, a diameter and a pitch of the second screw blade 563 are changed from the diameter and the pitch of the first screw blade 562. As shown in FIG. 4A, when the radius (the height) of the first screw blade 562 is represented as H, the radius (height h1) of the second screw blade 563 is smaller than H. As shown in FIG. 5, when the pitch of spirals of the first screw blade 562 is represented as P, a pitch p1 of the second screw blade 563 is set smaller than the pitch P.

To obtain a satisfactory image necessary to stabilize the discharge of an excess developer and reduce fluctuation in a discharge amount. A method for stably discharging the excess developer is explained below.

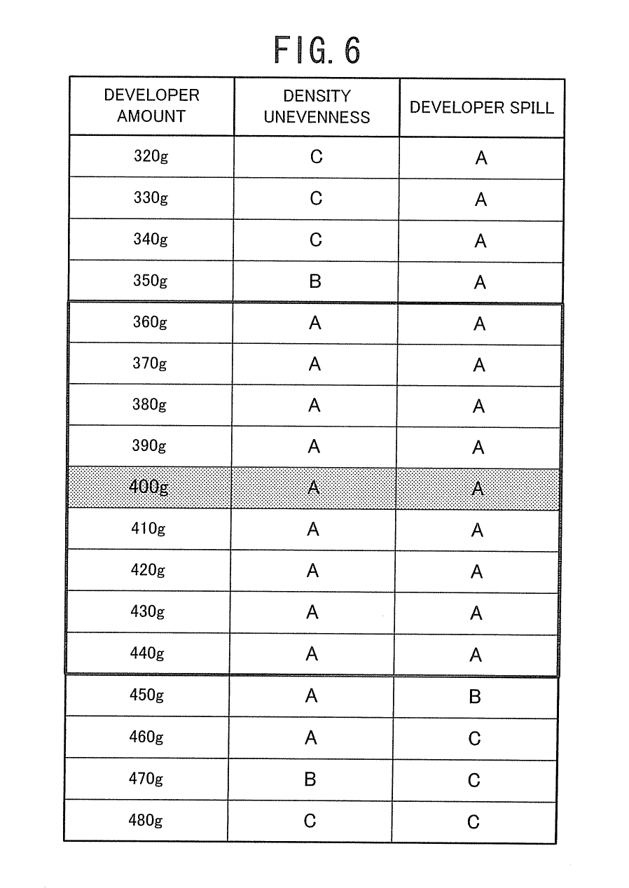

FIG. 6 is a table of an evaluation result obtained by measuring an image state and a state of a spill of the developer when the developer is put in the developer container 51 with the discharge port 58 closed and a developer amount is gradually increased in order to check a satisfactory developer amount in the developer container 51.

When a specified developer amount of the developer container 51 was set to 400 g and an image state and a state of a spill of the developer after taking one hundred copies of a photograph image at a printing ratio of 30% were observed, a result shown in FIG. 6 was obtained. In FIG. 6, A indicates good, B indicates poor, and C indicates fair between good and poor.

As seen from FIG. 6, when the developer amount in the developer container 51 is equal to or smaller than 350 g, density unevenness occurs. When the developer amount is equal to or larger than 470 g, density unevenness due to spiral traces of the mixers 55 and 56 occurs. When the developer amount is equal to or larger than 450 g, a spill of the developer occurs. Therefore, the image state and the state of the spill are good when the developer amount is 360 g to 440 g, i.e., in a range of ±10% with respect to the specified developer amount (400 g).

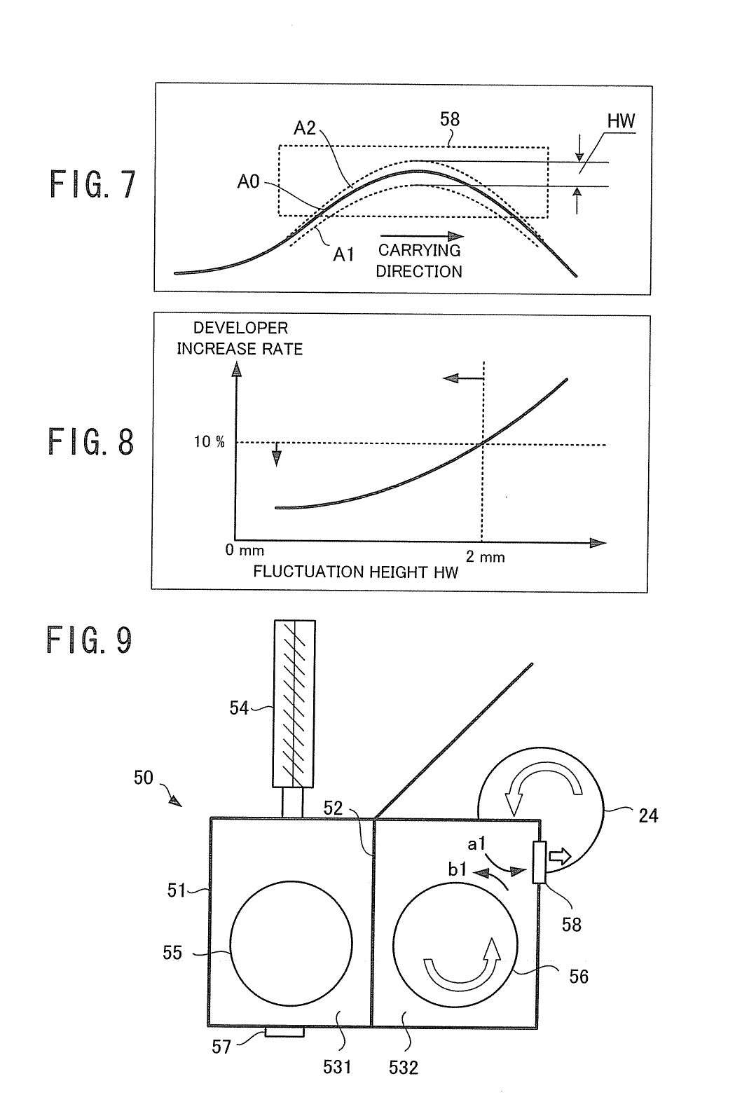

Fluctuation height of the heap of the developer near the discharge port 58 is explained. The fluctuation height is calculated from a fluctuation state of the heap of the developer shown in FIG. 7. Specifically, when the heap height of the developer fluctuates from a minimum characteristic A1 to a maximum characteristic A2, a difference of fluctuation (A2−A1) is represented as fluctuation height HW. A characteristic A0 is an intermediate characteristic between the characteristic A1 and the characteristic A2.

A heap state of the developer was photographed by a video camera, photographed images were captured as still images, and the fluctuation height HW was calculated from a still image of a minimum heap state and a still image of a maximum heap state.

FIG. 8 is a graph of a result obtained by measuring a rate of increase of the developer (the ordinate) on the basis of the weight of the developer discharged from the discharge port 58 of the mixer 56 and verifying a relation between the rate of increase of the developer and the fluctuation height HW (the abscissa). The rate of increase of the developer fell as the fluctuation height HW decreased. At the fluctuation height HW equal to or smaller then 2 mm, the rate of increase of the developer fell to be equal to or lower than 10%. Stable discharge can be performed by reducing the fluctuation height HW. At the fluctuation height HW equal to or smaller than 2 mm, the rate of increase of the developer is equal to or lower than 10%. Therefore, a high-quality image without density unevenness and a developer spill can be stably output. The fluctuation height HW equal to or larger than 2 mm is undesirable because the rate of increase of the developer rises.

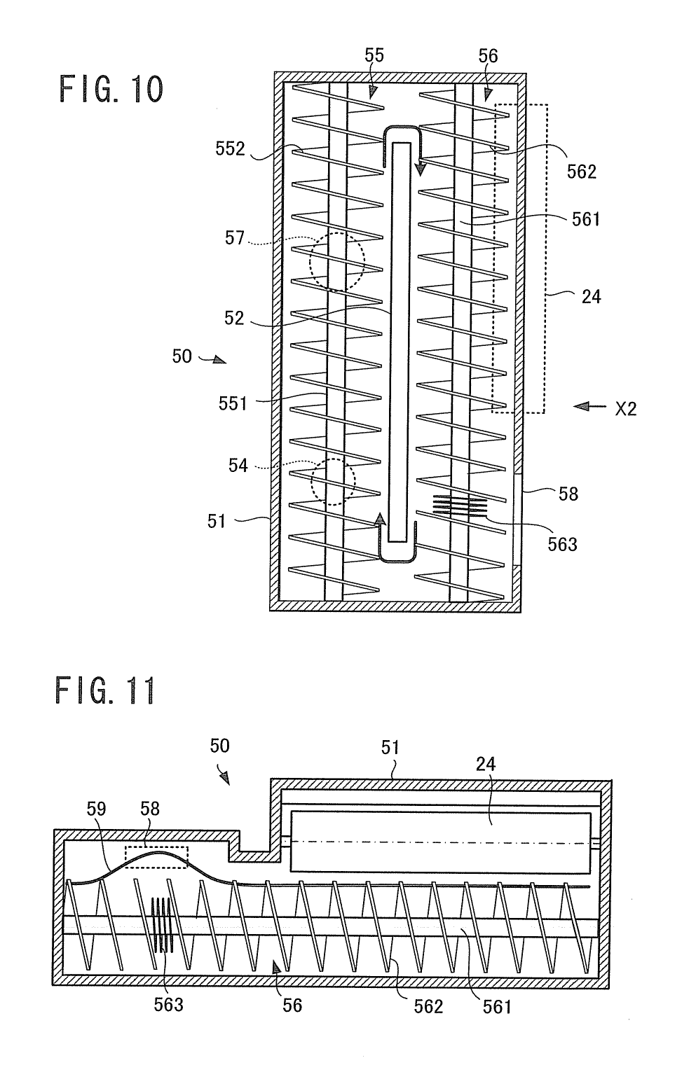

Rotating directions of the mixers 55 and 56 were verified. FIGS. 9 to 11 are diagrams of the developing device 50 in which the arrangement positions of the mixers 55 and 56 are horizontally reversed and the position of the discharge port 58 is also changed to a position of the mixer 56 opposed to the second screw blade 563. The position of the developing roller 24 is also changed to the right side as shown in FIGS. 10 and 11. FIG. 11 is a side view of the developing device 50 viewed from an arrow X2 direction in FIG. 10. A part of the developing device 50 is shown in section.

In the developing device 50 shown in FIG. 9, the rotating directions of the mixers 55 and 56 and the developing roller 24 are the same as shown in FIG. 3. Therefore, as shown in FIG. 10, the developer circulates in the clockwise direction from the mixer 55 to the mixer 56 as indicated by a thick arrow. The mixer 56 rotates in a direction (an arrow b1) for scraping up the developer toward the discharge port 58 as shown in FIG. 9. The opposed surfaces of the developing roller 24 and the mixer 56 rotate in the “against” directions (arrows a1 and b1).

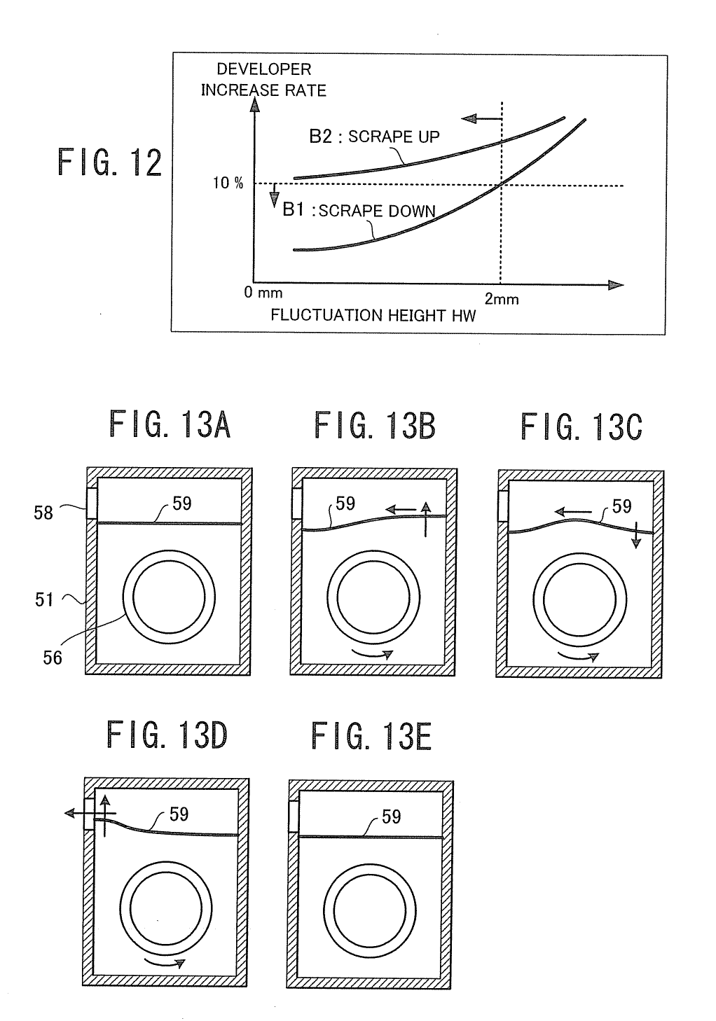

A result obtained by checking a relation of the rate of increase of the developer and the fluctuation height HW with respect to the rotating direction of the mixer 56 is shown in FIG. 12.

B1 in FIG. 12 indicates the rate of increase of the developer (the ordinate) and the fluctuation height HW (the abscissa) at the time when the mixer 56 is rotated in a scraping-down direction (FIG. 3). B2 indicates at the time when the mixer 56 is rotated in a scraping-up direction (FIG. 9).

As seen from FIG. 12, the rate of increase of the developer with respect the fluctuation height HW is lower when the mixer 56 is rotated in the scraping-down direction. When the mixer 56 is rotated in the scraping-down direction, at the fluctuation height HW equal to or smaller than 2 mm, the rate of increase of the developer is equal to or lower than 10%. When the flow of the developer was observed, the following was found.

FIGS. 13A to 13E are diagrams in which the movement of the developer surface 59 in the developer container 51 is simulatively shown plainly. The mixer 56 rotates in the counterclockwise direction and, near the discharge port 58, rotates in the direction for scraping down the developer. The discharge port 58 is provided in the wall surface of the developer container 51 on a side on which the developer is scraped down.

In FIG. 13A, an initial state of the developer surface 59 is shown, a state in which the developer does not start to be carried yet. If the developer surface 59 is in a substantially flat state, when the mixer 56 rotates in the counterclockwise direction, in FIG. 13B, the developer surface 59 moves to the left while rising on the right side (the first wall surface side) of the developer container 51. In FIG. 13C, the developer surface 59 rises in the center and falls on the right side. In FIG. 13D, the developer surface 59 moves to the left while rising on the left side (the second wall surface side). In FIG. 13E, the developer surface 59 returns to the original state (FIG. 13A). The developer surface 59 repeats the states shown in FIGS. 13A to 13D and moves as if waves sweep toward the discharge port 58. Therefore, the developer is discharged from the discharge port 58 by an overflow not only in a state in which the developer surface 59 rises but also in a state in which the developer is pushed out.

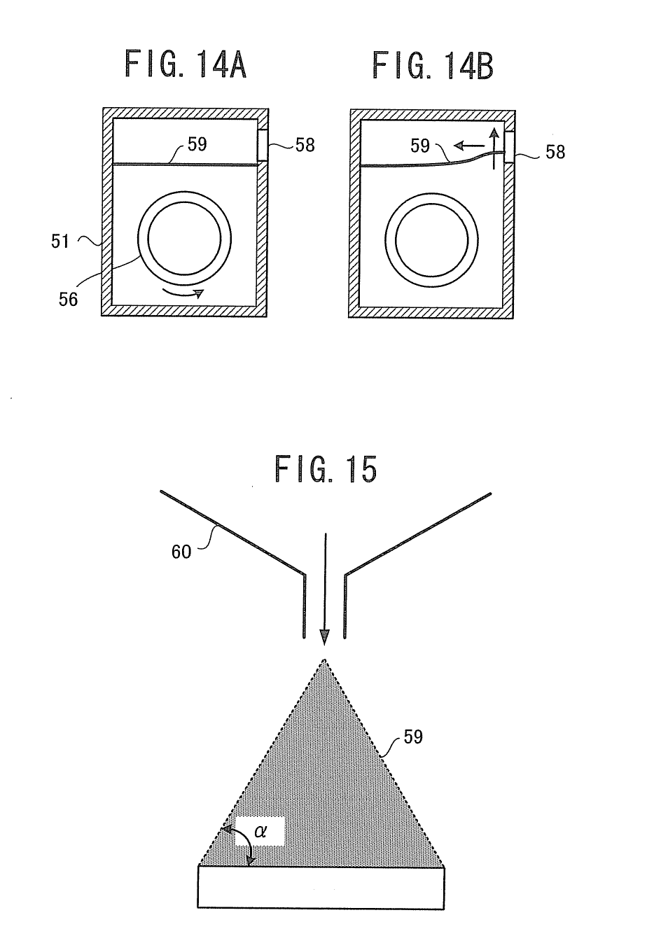

The movement of the developer surface 59 that occurs when the discharge port 58 is provided on a side on which the developer is scraped up as shown in FIG. 9 is explained with reference to FIGS. 14A and 14B. In FIG. 9, the developer near the discharge port 58 moves in the scraping-up direction. When the mixer 56 starts rotating in a state shown in FIG. 14A, as shown in FIG. 14B, the developer surface 59 moves in a direction opposite to the discharge port 58 (the left direction) while rising near the discharge port 58.

The developer is discharged by an overflow from the discharge port 58. However, since a rising portion moves to the opposite side of the discharge port 58, unlike the state shown in FIG. 13D, the developer is not pushed out.

Therefore, seen that the discharge of the developer is more stable when the discharge port 58 is provided on the side on which the developer is scraped down (the second wall surface) as shown in FIG. 3.

To check the influence of fluidity of the developer, fluidity was verified by using developers having different angles of repose. The angle of repose is explained with reference to FIG. 15. When the developer is dropped from a funnel 60, the developer gradually piles up in an isosceles triangular mountain shape with an angle of repose α. When the angle of repose α reaches a certain inclination angle, the mountain collapses. The inclination angle at the limit of collapse is set as the angle of repose. The fluidity of the developer is poorer as the angle of repose is larger.

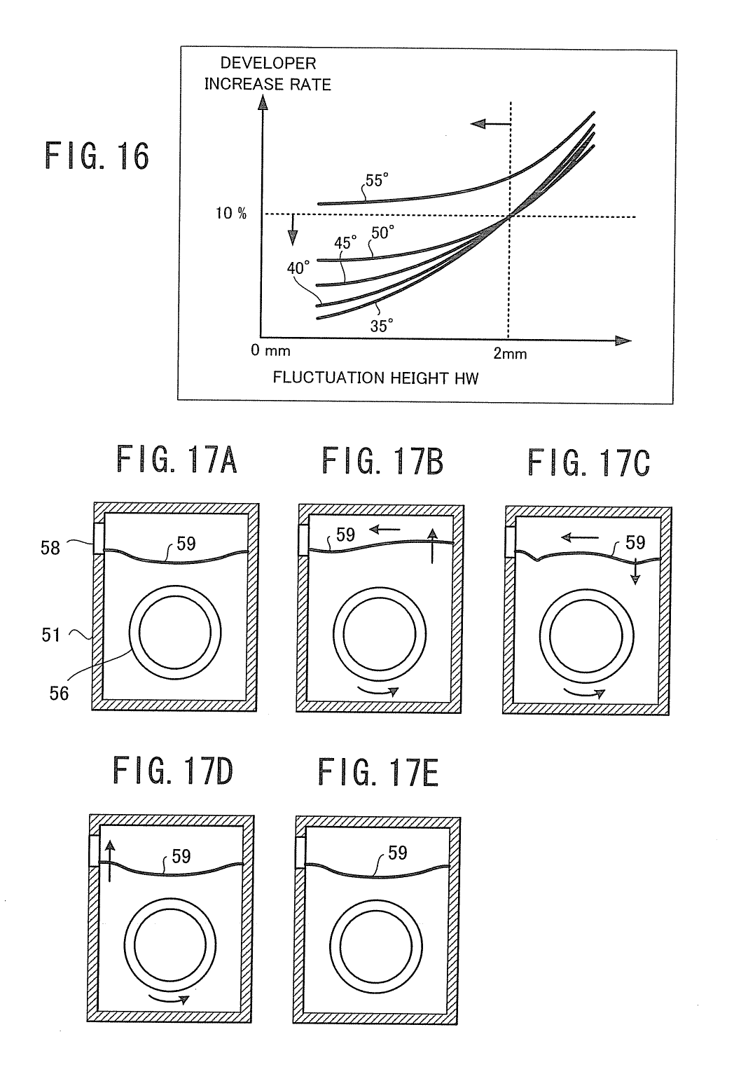

A result obtained by putting developers having different angles of repose in the mixer 56 shown in FIGS. 3 to 5 and checking a relation between rates of increase of the developers and the fluctuation height HW is shown in FIG. 16. Developers having angles of repose of 35 degrees to 55 degrees were used. The developer having a larger angle of repose a has a higher rate of increase of the developer with respect to the fluctuation height HW. And also seen that the developer having the angle of repose of 55 degrees has a rate of increase of the developer exceeding 10%.

When the flow of the developer was observed, the following was found. That is confirmed that the developer surface 59 of the developer having the angle of repose of 40 degrees moved as shown in FIGS. 13A to 13E. On the other hand, the developer surface 59 of the developer having the angle of repose of 55 degrees moved as shown in FIGS. 17A to 17E.

The mixer 56 rotates counterclockwise as indicated by an arrow. The discharge port 58 is formed on the left wall surface such that the developer is scraped down. When the mixer 56 rotates, as shown in FIG. 17B, the developer surface 59 moves to the left while rising on the right side. And, as shown in FIG. 17C, the developer surface 59 rises in the center, falls on the right side, and moves to the left while rising on the left side.

The developer is discharged from the discharge port 58 by an overflow in a state in which the developer surface 59 rises and the developer is pushed out. However, when the flow of the developer was closely observed, confirmed that the developer flowed only in the periphery of the mixer 56 and hardly flowed near the wall surfaces of the developer agitating passage.

When the fluidity of the developer is deteriorated, the flow of the developer near the agitating passage worsens. Even in a state in which the rotation of the mixer 56 is stopped, as shown in FIG. 17A or 17E, the developer surface 59 slightly rises near the agitating passage (near the wall surfaces) compared with the center of the mixer 56. Specifically, although the developer surface 59 moves while rising on the left side as shown in FIGS. 17B to 17D, the flow of pushing out the developer to the discharge port 58 is hindered compared with FIGS. 13A to 13E. Therefore, the fluidity of the developer is deteriorated, the discharge of an excess developer worsens, and the developer increases.

The developer having the angle of repose of 45 degrees moved in the same manner as the developer having the angle of repose of 40 degrees. When the angle of repose was 50 degrees, the developer moved in an intermediate manner between the manners shown in FIGS. 13 and 17.

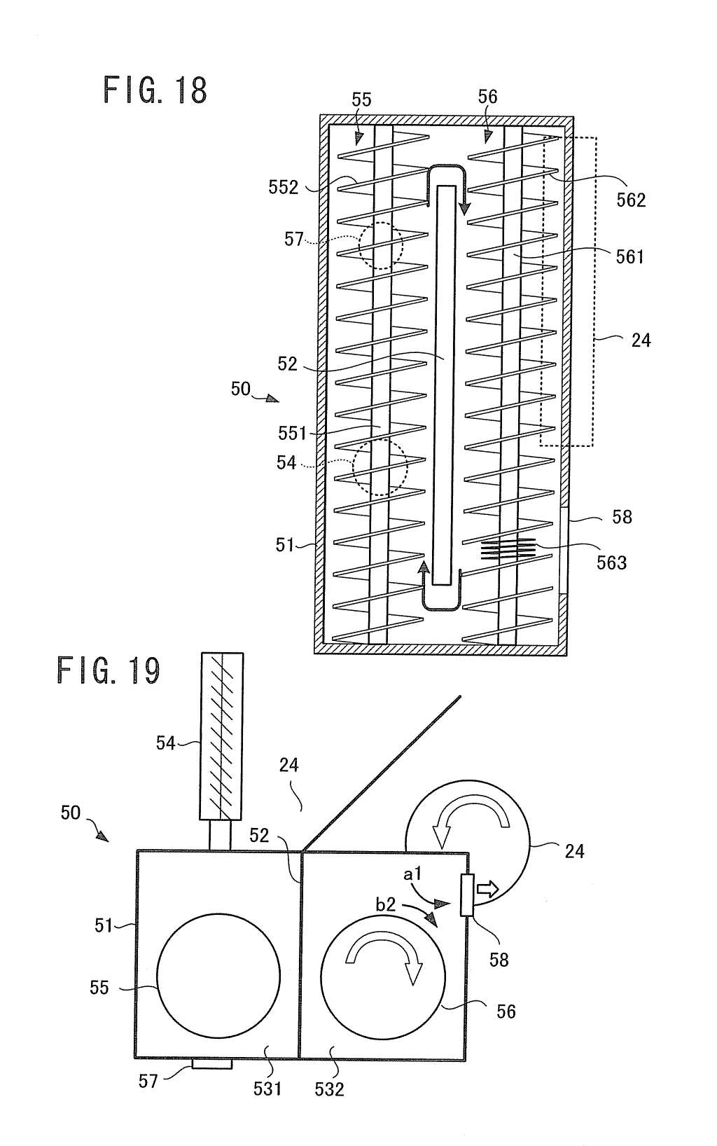

In order to check the rotating directions of the developing roller 24 and the mixer 56, a situation of occurrence of image unevenness was verified by using the developing device 50 shown in FIGS. 18 and 19. In the developing device 50 shown in FIGS. 18 and 19, the mixers 55 and 56 arranged to be horizontally reversed from shown in FIG. 4 and having a spiral direction different from that shown in FIG. 4 are used. The rotating direction of the mixers 55 and 56 is different from that shown in FIG. 4.

In FIG. 18, the developer circulates in the clockwise direction as indicated by a thick arrow. As shown in FIG. 19, the mixer 56 rotates in a developer scraping-down direction (an arrow b2). The opposed surfaces of the developing roller 24 and the mixer 56 rotate in circumferential directions coinciding with each other (“with” directions) as indicated by arrows a1 and b2.

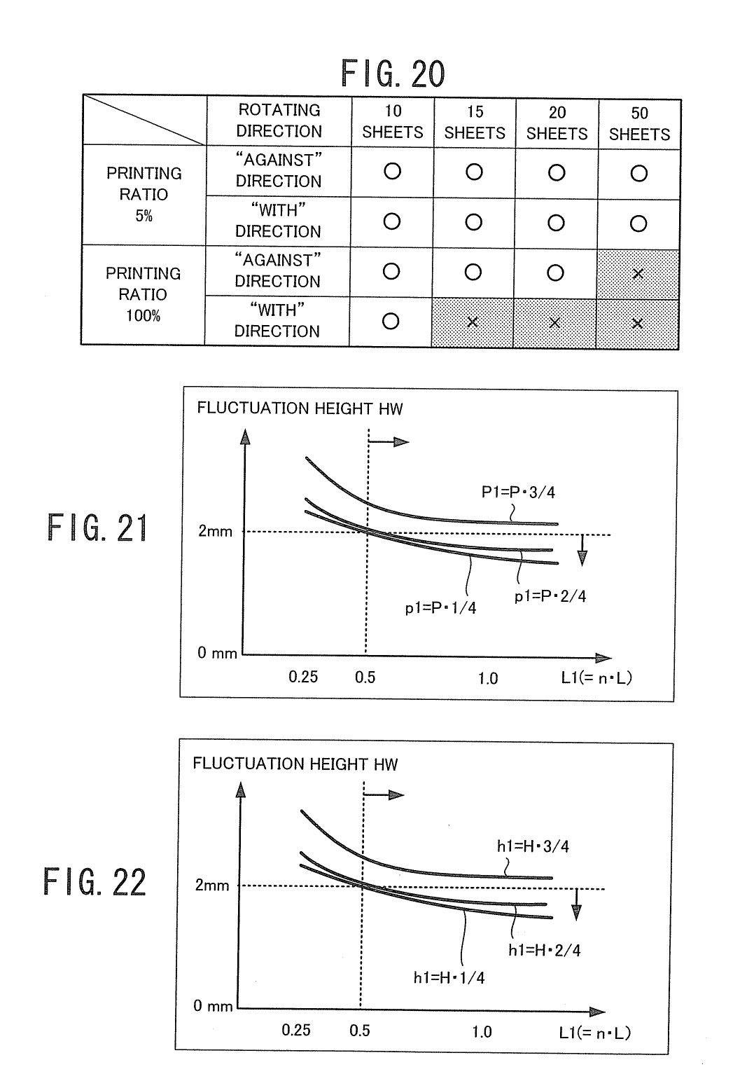

As verification, a degree of unevenness that occurs in images output by the developing device 50 shown in FIGS. 3 to 5 and the developing device 50 shown in FIGS. 18 and 19 was evaluated in terms of the number of sheets as a limit of occurrence of the unevenness. A verification result is shown in FIG. 20.

In FIG. 20, unevenness of images in the “against” directions and the “with” directions at a printing ratio of 5% and a printing ratio of 100% is shown. As seen from FIG. 20, at the printing ratio of 5%, no unevenness of images is seen in both the “against” directions and the “with” directions. However, at the printing ratio of 100%, although no unevenness of images occurred in the “against” directions until twenty sheets were printed, unevenness of images occurred in the “with” directions when the number of sheets exceeded ten.

From verification result, seen that unevenness of images less easily occurs when the developing roller 24 and the mixer 56 rotate in the “against” directions. According to the rotation in the “against” directions, the developer is easily accumulated on the developing roller 24 and the supply of the toner onto the developing roller 24 is stabilized. At the printing ratio of 100% with large toner consumption, when the developing roller 24 and the mixer 56 rotated in the “against” directions, the images were satisfactorily formed until sheets twice as many as printed when the developing roller 24 and the mixer 56 rotated in the “with” directions were printed.

In other words, in a copying machine mounted with the developing device 50, when images having a high printing ratio are continuously output, toner supply is immediately required and convenience falls in a configuration in which the developing roller 24 and the mixer 56 rotate in the “with” directions.

In the developing device 50 shown in FIGS. 4 and 5, the fluctuation height HW was measured with the shape (the width, the diameter, and the pitch) of the second screw blade 563 changed.

First, the shape (the pitch, the diameter, and the width) of the second screw blade 563 is explained. When the pitch of the first screw blade 562 of the mixer 56 is represented as P as shown in FIG. 5, the fluctuation height HW was measured with the pitch p1 of the second screw blade 563 set to ¼, 2/4, and ¾ with respect to the pitch P.

The diameter is the outer diameter (the blade height) of the second screw blade 563. The fluctuation height HW was measured with the height h1 of the second screw blade 563 set to ¼, 2/4, and ¾ with respect to the height H of the first screw blade 562.

As shown in FIG. 4B, the width is area width L1 in the axis direction of the second screw blade 563. When the width of the pitch of the first screw blade 562 is represented as L, the fluctuation height HW was measured with the area width L1 of the second screw blade 563 set to ¼ to two times with respect to the width L.

FIG. 21 is a characteristic chart of the fluctuation height HW at the time when the area width L1 of the second screw blade 563 (the abscissa) and the pitch p1 of the second screw blade 563 are changed. The fluctuation height HW decreases as the width L1 increases. And found that, when the width L1 was larger than L/2 (=0.5 times) and the pitch p1 was P* 2/4 and P*¼, the fluctuation height HW was smaller than 2 mm. Therefore seen that, if the width L1 is larger than L/2 (=0.5) and the pitch p1 is equal to or smaller than P*½, the fluctuation height HW can be held down to be equal to or smaller than 2 mm.

FIG. 22 is a characteristic chart of the fluctuation height HW at the time when the area width L1 of the second screw blade 563 (the abscissa) and the height h1 of the second screw blade 563 are changed. The fluctuation height HW decreases as the width L1 increases. And found that, when the width L1 was larger than L/2 (=0.5) and the blade height h1 was H* 2/4 and H*¼, the fluctuation height HW was smaller than 2 mm. Therefore seen that, if the width L1 is larger than L/2 (=0.5) and the blade height h1 is equal to or smaller than H/2, the fluctuation height HW can be held down to be equal to or smaller than 2 mm.

Consequently, to reduce the fluctuation height HW to be equal to or smaller than 2 mm, desirable to set the area width L1 of the second screw blade 563 to be equal to or larger than L/2 and set the pitch p1 to be equal to or smaller than P/2 or set the width L1 to be equal to or larger than L/2 and set the blade height h1 to be equal to or smaller than H/2.

According to the embodiment explained above, possible to stably discharge the excess developer by reducing fluctuation in the heap of the developer near the discharge port 58.

The present invention is not limited to the embodiment and various modifications of the embodiment are possible. For example, although the system employing the intermediate transfer belt 21 is explained above, a system not employing the intermediate transfer belt 21 may be adopted.

What is claimed is:

1. A developing device comprising:
a developing roller configured to shift a toner onto a surface of an image bearing member;
a container configured to store a developer and have an agitating passage for supplying the developer to the developing roller, the agitating passage having a first wall surface and a second wall surface opposed to each other;
a rotatable agitating member configured to carry the developer along the agitating passage while agitating the developer;
a discharge port configured to be provided in one of the first wall surface and the second wall surface and discharge an excess developer involved in the supply of the developer; and
a heaping member configured to heap the developer relatively to the discharge port according to the agitation of the agitating member, wherein
the discharge port is located in a direction in which the developer is scraped down according to the agitation of the agitating member.

2. The device of claim 1, wherein the discharge port is provided in a position higher than the agitating passage.

3. The device of claim 1, wherein
the agitating member includes a spiral first screw blade arranged on a rotating shaft provided along the agitating passage, and
the heaping member includes a spiral second screw blade provided in a position opposed to the discharge port on the rotating shaft and having a diameter smaller than a diameter of the first screw blade.

4. The device of claim 1, wherein
the agitating member includes a spiral first screw blade arranged at a predetermined pitch on a rotating shaft provided along the agitating passage, and
the heaping member includes a spiral second screw blade provided in a position opposed to the discharge port on the rotating shaft and having a pitch smaller than a pitch of the first screw blade.

5. The device of claim 1, wherein
the agitating member includes a spiral first screw blade arranged at a predetermined pitch on a rotating shaft provided along the agitating passage, and
the heaping member includes a spiral second screw blade provided in a position opposed to the discharge port on the rotating shaft and having a diameter and a pitch smaller than a diameter and a pitch of the first screw blade.

6. The device of claim 5, wherein, in the heaping member, the pitch of the second screw blade is equal to or smaller than a half of the pitch of the first screw blade and area width in an axis direction of the second screw blade is equal to or larger than a half of pitch width of the first screw blade.

7. The device of claim 5, wherein height of the second screw blade is equal to or smaller than a half of height of the first screw blade and area width in an axis direction of the second screw blade is equal to or larger than a half of pitch width of the first screw blade.

8. The device of claim 1, wherein an angle of repose, which indicates fluidity of the developer, is equal to or smaller than 50 degrees.

9. The device of claim 1, wherein opposed surfaces of the agitating member and the developing roller rotate in “against” directions.

10. A developing method comprising:
providing a developing roller configured to shift a toner onto a surface of an image bearing member;
storing the developer in a container configured to have an agitating passage for supplying the developer to the developing roller;
carrying, with an agitating member, the developer along the agitating passage while agitating the developer;
providing a discharge port in one of wall surfaces of the container on a side on which the developer is scraped down in the agitating passage;
heaping, with a heaping member, the developer near the discharge port; and
causing the developer to overflow and discharging an excess developer involved in supply of the developer from the discharge port.

11. The method of claim 10, further comprising providing the discharge port in a position higher than the agitating passage.

12. The method of claim 10, wherein
the agitating member includes a spiral first screw blade arranged on a rotating shaft provided along the agitating passage, and
the heaping member includes a spiral second screw blade provided in a position opposed to the discharge port on the rotating shaft and having a diameter smaller than a diameter of the first screw blade.

13. The method of claim 10, wherein
the agitating member includes a spiral first screw blade arranged at a predetermined pitch on a rotating shaft provided along the agitating passage, and
the heaping member includes a spiral second screw blade provided in a position opposed to the discharge port on the rotating shaft and having a pitch smaller than a pitch of the first screw blade.

14. The method of claim 10, wherein
the agitating member includes a spiral first screw blade arranged at a predetermined pitch on a rotating shaft provided along the agitating passage, and
the heaping member includes a spiral second screw blade provided in a position opposed to the discharge port on the rotating shaft and having a diameter and a pitch smaller than a diameter and a pitch of the first screw blade.

15. The method of claim 14, further comprising setting the pitch of the second screw blade to be equal to or smaller than a half of the pitch of the first screw blade and setting area width in an axis direction of the second screw blade to be equal to or larger than a half of pitch width of the first screw blade.

16. The method of claim 14, further comprising setting height of the second screw blade to be equal to or smaller than a half of height of the first screw blade and setting area width in an axis direction of the second screw blade to be equal to or larger than a half of pitch width of the first screw blade.

17. The method of claim 10, further comprising using a developer having an angle of repose, which indicates fluidity, equal to or smaller than 50 degrees as the developer.

18. The method of claim 10, wherein opposed surfaces of the agitating member and the developing roller rotate in “against” directions.

19. An image forming apparatus comprising:
an image bearing member;
a charging unit configured to charge a surface of the image bearing member;
an exposing unit configured to expose the surface of the charged image bearing member to form an electrostatic latent image;
a developing roller configured to shift a toner onto the surface of the image bearing member and develop the electrostatic latent image with the toner;
a transfer unit configured to transfer a visible image obtained by developing the electrostatic latent image onto a recording medium;
a container configured to store a developer and have an agitating passage for supplying the developer to the developing roller, the agitating passage having a first wall surface and a second wall surface opposed to each other;
a rotatable agitating member configured to carry the developer along the agitating passage while agitating the developer;
a discharge port configured to be provided in one of the first wall surface and the second wall surface and discharge an excess developer involved in the supply of the developer; and
a heaping member configured to heap the developer relatively to the discharge port according to the agitation of the agitating member, wherein
the discharge port is located in a direction in which the developer is scraped down according to the agitation of the agitating member.

20. The apparatus of claim 19, wherein
the agitating member includes a spiral first screw blade arranged at a predetermined pitch on a rotating shaft provided along the agitating passage, and
the heaping member includes a spiral second screw blade provided in a position opposed to the discharge port on the rotating shaft and having a diameter and a pitch smaller than a diameter and a pitch of the first screw blade.
